(19) United States
(12) Patent Application Publication
(10) Pub. No.: US 2009/0308545 A1
(43) Pub. Date: Dec. 17, 2009

(54) ROLLING DEVICE FOR ROLL BLIND

(76) Inventor: Eun Ro An, Seongnam-si (KR)

Correspondence Address: SCHMEISER OLSEN & WATTS, 18 E UNIVERSITY DRIVE, SUITE # 101, MESA, AZ, 85201, US

(21) Appl. No.: 12/519,736

(22) PCT Filed: Jan. 3, 2008
(86) PCT No.: PCT/KR2008/000028

§ 371 Date: Jun. 17, 2009

(30) Foreign Application Priority Data
Jan. 4, 2007 (KR) 10-2007-0003148
Nov. 9, 2007 (KR) 10-2007-0114291

(51) Int. Cl. E06B 9/56; E06B 9/42

(52) U.S. Cl. 160/313

(57) ABSTRACT

The present invention relates to a rolling device for roll blind comprising a roll pipe assembly having a tunner therein in an extending direction; a pair of cover assemblies inserted into and coupled to both end parts of the roll pipe assembly; a fixing shaft accommodated in the tunnel of the roll pipe assembly and having both end parts prevented from being rotated by each cover assembly; and a spring assembly being an elastic rotating element which is accommodated in the roll pipe assembly and accommodates the fixing shaft therein, and having one end part which is integrally rotated with the roll pipe assembly and the other end part whose rotation is prevented by the fixing shaft. According to the present invention, various curtain sheets with different kinds of material and a blind made of bamboo, reed or other whose rolling thickness is increased as well can be used in the roll blind.

### TECHNICAL FIELD

The present invention relates to a rolling device for a roll blind.

### BACKGROUND ART

A conventional roll blind is classified into a so-called roman shade curtain where a curtain sheet is folded through four steps from its lower end part and moved vertically by using a pulling string that is drawn out from an roll adjusting device provided at the top, and a so-called roll screen where a stiff coated roll paper is rolled around a roll pipe provided at the top to be moved vertically thus forming a shutting screen between inside and outside of a window.

However, if a thickness of the curtain sheet of the roman shade curtain or the roll paper of the roll screen is not uniform, the curtain sheet or the roll paper moves in one axial direction while it is rolled around the roll adjusting or the roll pipe.

Moreover, if a thickness of the curtain sheet or the roll paper is increased, a rolled state thereof occupies a huge space. Therefore, a thick curtain sheet or roll paper cannot be used substantially and only a thin curtain sheet or roll paper has to be used for its use.

In addition, it is difficult to detach or re-attach the curtain sheet or the roll paper once it is attached to the roll blind, so that the roll blind shall be abandoned when used over a predetermined period and shall be replaced by a new one.

### DISCLOSURE OF INVENTION

### Technical Problem

It is an object of the present invention to provide a rolling device for roll blind which is provided at a lower end part of a curtain sheet that is moved vertically, so that various curtain sheets with different kinds of material and a blind made of bamboo, reed or other whose rolling thickness is increased as well can be used in the roll blind.

It is another object of the present invention to provide a rolling device for roll blind where a magic tape is respectively applied to an upper end part and a lower end part of the curtain sheet which are attached to an adjusting device provided at the top of the roll blind and to a rolling device provided at a lower end thereof, so that the curtain sheet can be easily detached or re-attached.

### Technical Solution

To achieve the above object, according to an aspect of the present invention, there is provided a rolling device for roll blind comprising: a roll pipe assembly having a tunner therein in an extending direction; a pair of cover assemblies inserted into and coupled to both end parts of the roll pipe assembly; a fixing shaft accommodated in the tunnel of the roll pipe assembly and having both end parts prevented from being rotated by each cover assembly; and a spring assembly being an elastic rotating element which is accommodated in the roll pipe assembly and accommodates the fixing shaft therein, and having one end part which is integrally rotated with the roll pipe assembly and the other end part whose rotation is prevented by the fixing shaft.

According to another aspect of the present invention, the rolling device for roll blind may further comprise a pulling bar assembly which is disposed in parallel with the roll pipe assembly and has both end parts coupled to each cover assembly, and which is coupled to a pulling chain at the opposite side from the roll pipe assembly.

According to another aspect of the present invention, the roll pipe assembly may have a cylindrical roll pipe which accommodates the fixing shaft, the spring assembly may have a roll driving element which is integrally rotated with the roll pipe, a fixing element whose rotation is prevented by the fixing shaft, and a driving spring which has an end part that is integrally rotated with the roll driving element and the other end part that is fixed by the fixing element.

According to another aspect of the present invention, the roll pipe assembly may have a cylindrical roll pipe which accommodates the fixing shaft, the cover assembly may have a roll socket which is inserted into an end part of the roll pipe and to be integrally rotated with the roll pipe and a roll cover which rotatably supports the roll socket, and the roll socket and the roll cover may have a braking hole respectively to correspond to each other in a radial direction.

### Advantageous Effects

According to a rolling device for roll blind of the present invention, the rolling device is provided at a lower end part of a curtain sheet that is moved vertically, so that various curtain sheets with different kinds of material and a blind made of bamboo, reed or other whose rolling thickness is increased as well can be used in the roll blind.

Also, according to the rolling device for roll blind of the present invention, a magic tape is respectively applied to an upper end part and a lower end part of the curtain sheet which are attached to an adjusting device provided at the top of the roll blind and to a rolling device provided at a lower end therof, so that the curtain sheet can be easily detached or re-attached and accordingly the curtain sheet can be easily washed, replaced or repaired.

### BRIEF DESCRIPTION OF THE DRAWINGS

FIG. 1 is a front side perspective view of a rolling device for roll blind according to an exemplary embodiment of the present invention when it is applied in a roll blind,

FIG. 2 is a rear side perspective view of the rolling device of FIG. 1,

FIG. 3 shows an attachment of a curtain sheet in the roll blind of FIG. 1,

FIG. 4 shows a partially sectional perspective view of a principal part of the roll blind of FIG. 1,

FIG. 5 is an exploded perspective view of the rolling device for roll blind of FIG. 1,

FIG. 6 is an exploded perspective view of a principal part of a spring assembly in the rolling device for roll blind of FIG. 1,

FIG. 7 is a perspective view of a principal part of the spring assembly in the rolling device for roll blind of FIG. 1,

FIG. 8 is a partially sectional perspective view of a principal part of the spring assembly in the rolling device for roll blind of FIG. 1.

### BEST MODE FOR CARRYING OUT THE INVENTION

The present invention relates to a rolling device for roll blind where a curtain sheet is rolled from its lower end part and moves vertically to form a shutting screen or to be removed. Hereinafter, a structure and an operation of the rolling device for roll blind according to an exemplary embodiment of the present invention is described in detail.

Also, the present invention incorporates technical features described in a Korean patent registration No. 10-0581484 “ROMAN SHADE CURTAIN” which is registered on May 12, 2006 and a Korean patent registration No. 10-0757647 “VERTICALLY MOVING BILOW, ROMAN SHADE AND BLIND” which is registered on Sep. 4, 2007. Accordingly, the technologies introduced in the two patents shall be included in this specification.

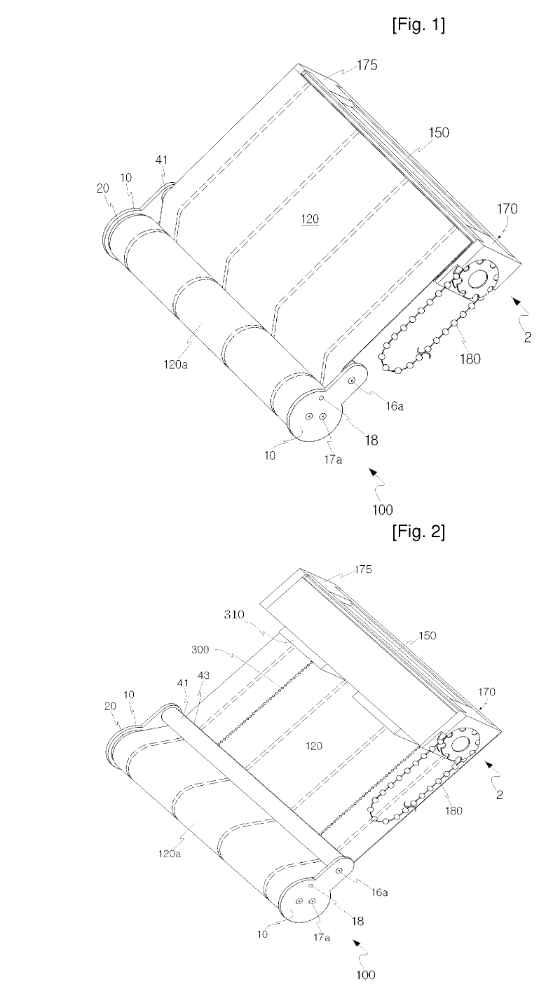

FIG. 1 is a front side perspective view of a rolling device for roll blind according to an exemplary embodiment of the present invention when it is applied in a roll blind. FIG. 2 is a rear side perspective view of the rolling device of FIG. 1 and FIG. 3 shows an attachment of a curtain sheet in the roll blind of FIG. 1.

Referring to FIG. 2, two or more pulling devices 310 for rolling pulling chains 300 are provided in a pulling bar 150. An adjuster 170 and an end piece 175 are coupled to both end parts of the rolling bar 150.

That is, a roman shade curtain shown in FIG. 1 to FIG. 3 includes a roman shade adjusting device 2 which moves a rolling device 100 vertically by using a driving chain 180 to operate the adjuster 170 thus winding or unwinding the pulling chain 300.

As shown in FIG. 3, a magic tape 132 is provided to the rolling bar 150.

Magic tapes 130 and 130a which are provided at an upper and a lower parts of the curtain sheet 120 are attached respectively to the magic tapes 132 and 133 which are provided to the rolling bar 150 and a roll pipe 81.

As the driving chain 180 is rotated in one or the other direction, the curtain sheet 120 is rolled onto or unrolled from the roll pipe 81 in the rolling device 100 from a lower end part thereof. Accordingly, the rolling device 100 is moved vertically.

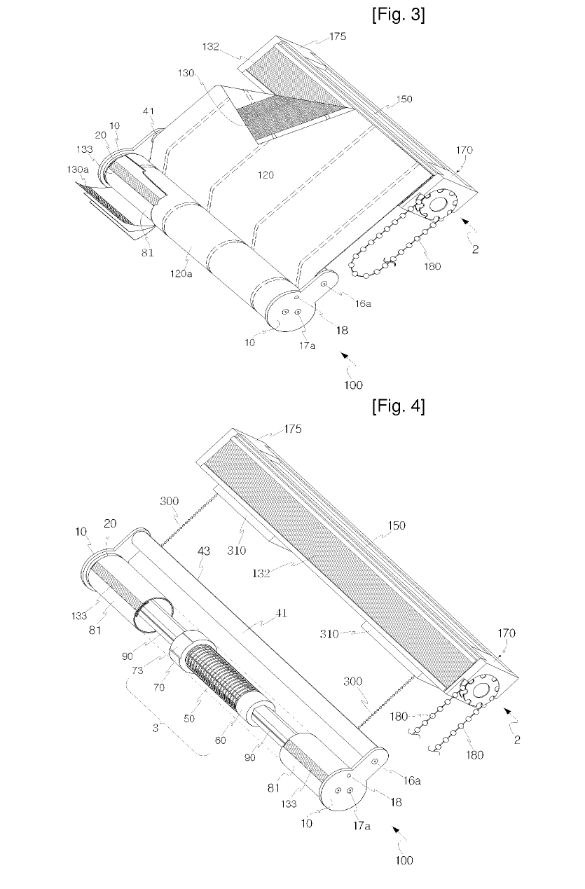

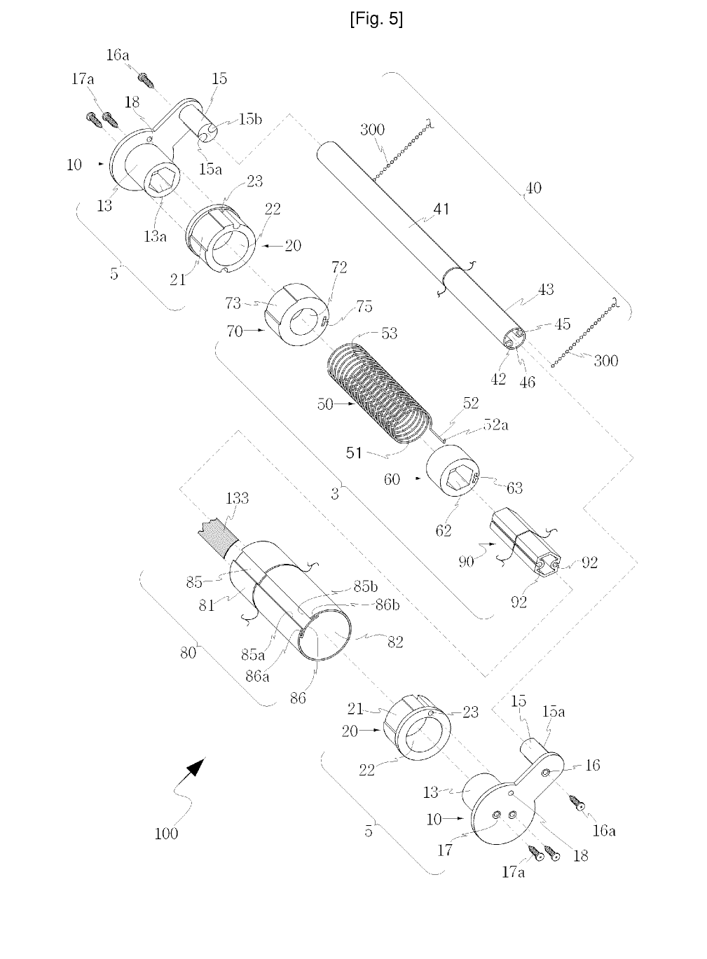

FIG. 4 shows a sectional perspective view of a principal part of the roll blind of FIG. 1 when the rolling device 100 for roll blind according to the exemplary embodiment of the present invention is assembled in the roll blind. FIG. 5 is an exploded perspective view of the rolling device 100.

Referring to FIG. 5, the rolling device 100 for roll blind includes a roll pipe assembly 80 which has a tunnel therein in an extending direction, a pair of cover assemblies 5 which are inserted and coupled to both end parts of the roll pipe assembly 80, a fixed shaft 90 which is accommodated in the tunnel of the roll pipe assembly 80 and whose both end parts are coupled to each cover assembly 5 not to be rotated, a spring assembly 3 as an elastic rotating element which is accommodated in the roll pipe assembly 80 and accommodates the fixed shaft 90 therein and which is integrally rotated with the roll pipe assembly 80 at one end thereof and is coupled to the fixed shaft 90 not to be rotated at the other end thereof.

Both end parts of the fixed shaft 90 and a pulling bar 41 are supported by roll covers 10.

The roll cover 10 has a braking hole 18 which passes through the roll cover 10 and a drum 13 which protrudes inwardly. The drum 13 has a hexagonal hole 13a at its inward center part, and a through hole 17 is formed in the hexagonal hole 13a. A pulling shaft 15 is formed to be spaced apart with an appropriate distance from the drum 13 and has removed parts 15a and 15b at upper and lower parts thereof.

A roll socket 20 is assembled between the roll cover 10 and the roll pipe 81. The roll socket 20 has a depression 21 at its outer circumference, a passage 22 at its inner part to form a circular hole passing therethrough, and a braking hole 23.

The roll socket 20 is inserted into an end part of the roll pipe 81. In this case, a protrusion 86 of the roll pipe 81 is inserted into the depression 21. Accordingly, the roll socket 20 is integrally rotated with the roll pipe 81.

The roll cover 10 and the roll socket 20 are assembled together to form the cover assembly 5.

In this case, the drum 13 of the roll cover 10 is inserted into the passage 22 of the roll socket 20 to rotatably support the roll socket 20. The roll socket 20 has an appropriate distance with the drum 13 therebetween so that it can be easily rotated around the drum 13.

Also, the roll socket 20 and the roll cover 10 have the braking holes 23 and 18 at positions to correspond to each other in a radial direction. Usage of the bracking holes 23 and 18 is described later.

The cover assembly 5 is inserted and rotatably coupled to both end parts of the roll pipe 81 of the roll pipe assembly 80 through the drum 13.

A roll driving element 70 is assembled between the roll pipe 81 having a cylindrical shape and the driving spring 50.

The roll driving element 70 has a depression 73 formed at a part of an outer circumference thereof, a fixing hole 75 formed at a side thereof in an axial direction, and a center hole 72 formed to pass through an inner center part thereof. The center hole 72 is larger than an outer circumference of the fixing shaft 90 to be described later.

A driving spring 50 is assembled between the roll driving element 70 and a fixing element 60. The driving spring 50 has a center part 51 which forms enough space to accommodate the fixing shaft 90 therein and a protruding pins 52 and 53 with an appropriate length at both end parts of the driving spring 50.

The driving spring 50 is coupled to the fixing shaft 90 via the fixing element 60. The fixing element 60 has a hexagonal tunnel 62 which passes through an inner center part of the fixing element 60 and a fixing hole 63 which is formed at a part of an outer circumference of the fixing element 60.

The fixing shaft 90 is inserted into the fixing element 60 and the both roll covers 10. A mounting hole 92 is formed at an inner side of the fixing shaft which has a hexagonal shape. The fixing shaft 90 having such a shape can be manufactured by extrusion.

The spring assembly 3 is formed by assembling the roll driving element 70, the driving spring 50, the fixing element 60 and the fixing shaft 90 each of which is described above. Specifically, the protruding pin 52 formed at one end part of the driving spring 50 is inserted into the fixing hole 63 of the fixing element 60 and the other protruding pin 53 is inserted into the fixing hole 75 that is formed at the outer circumference of the roll driving element 70. Accordingly, the spring assembly 3 where the roll driving member 70, the driving spring 50 and the fixing member 60 are assembled together is formed.

Therefore, the fixing shaft 90 is inserted into the spring assembly 3 through the fixing element 60. Also, the spring assembly 3 is integrally coupled to the fixing shaft 90 through a fixing element 60 where one protruding pin 52 of the driving spring 50 is fixely inserted. At the same time, the spring assembly 3 is integrally rotated with the roll pipe 81 of the roll pipe assembly 80 through the roll driving element 70 where the other protruding pin 53 of the driving spring 50 is fixedly inserted. That is, the protrusion 86 of the roll pipe 81 is inserted into the depression 73 of the roll driving element 70.

Therefore, the spring assembly 3 is an elastic rotating element due to the driving spring 50 and is fixed to the roll pipe assembly 80 at one end part and is fixed to the fixing shaft 90 at the other end part.

The magic tape 133 and the roll pipe 81 are assembled together to form the roll pipe assembly 80.

The roll pipe assembly 80 has a depressed curved surface 85 which is formed at a part of its outer circumference, wings 85a and 85b which are spaced apart from each other to have the curved surface 85 therebetween, spaces 86a and 86b which are formed between the wings 85a, 85b and the curved surface 85, and a tunnel 82 which is formed to pass through the center part of the roll pipe 81.

In this case, the curved surface 85 forms a protruding part 86 which protrudes into the tunnel 82. The spaces 86a and 86b formed between the wings 85a, 85b and the curved surface 85 accommodates the magic tape 133.

The pulling chain 300 and the pulling bar 41 are assembled together to form the pulling bar assembly 40.

The pulling bar assembly 40 has a mounting hole 42 and a pulling hole 45 therein. The pulling hole 45 forms an incised part 43 at the outer circumference of the pulling bar 41. Therefore, a ball at the lower end part of the pulling chain 300 is inserted into the pulling hole 45, then the pulling chain 300 is positioned to an upper side of the incised part 43.

The mounting hole 42 is inserted into the removed part 15a of the pulling shaft 15 of the roll cover 10 to be fixed by a screw 16a. Accordingly, the pulling bar assembly 40 and the roll pipe assembly 80 are disposed to be parallel therebetween by the roll cover 10 of the cover assembly 5.

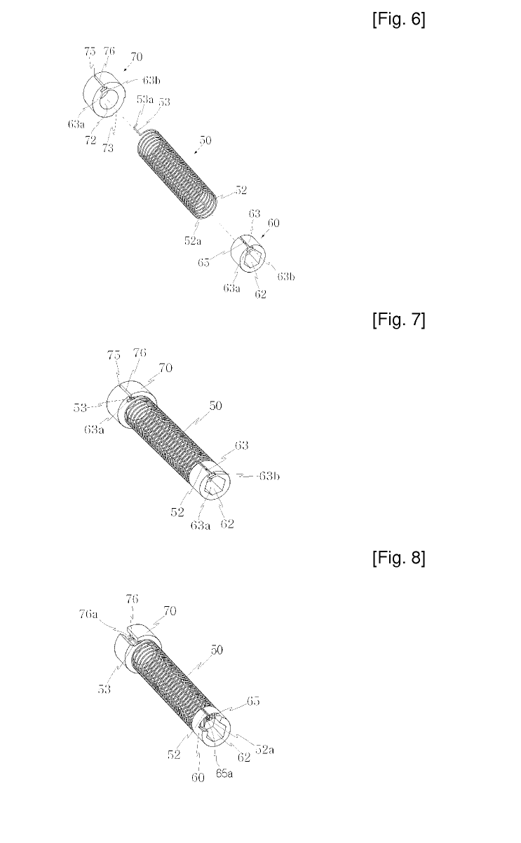

FIG. 6 is an exploded perspective view of a principal part of the spring assembly 3, FIG. 7 is a perspective view of a principal part of the spring assembly 3 in an assembled state, and FIG. 8 is a partially sectional perspective view of a principal part of the spring assembly 3.

As shown in FIG. 6 to FIG. 8, the spring assembly 3 has the protruding pins 53 and 52 which are formed at both end parts of the driving spring 50 and hooks 53a and 52a which are formed to be bent at the end part of the protruding pins 53 and 52.

The roll driving element 70 and the fixing element 60 have at their outer circumferences fixing holes 75, 63 which are formed to be depressed inward, spaces 63a, 63b which are formed at both sides of inner parts of the fixing holes 75, 63 and blocks 76, 65 which are formed at center parts of the fixing holes 75, 63.

Hereinafter, assembling process of the roll driving element 70, the driving spring 50 and the fixing element 60 is described.

The hooks 53a, 52a which are formed at both end parts of the driving spring 50 are inserted into the spaces 63b, 63a respectively and the protruding pins 53, 52 are inserted into the fixing holes 75, 63 respectively.

Then, the roll driving element 70 and the driving spring 50 are rotated in the opposite direction therebetween and the driving spring 50 and the fixing element 60 are rotated in the opposite direction therebetween, so that the hooks 53a, 52a are hooked to the blocks 76, 65. At this time, the protruding pins 53, 52 are inserted into the fixing holes 75, 63, thus completing the assembling of the roll driving element 70, driving spring 50 and the fixing element 60.

Hereinafter is described the assembling of the rolling device 100 which includes the cover assembly 5, the spring assembly 3, the roll pipe assembly 80 and the pulling bar assembly 40.

Referring to FIG. 4 and FIG. 5, a rotational position of the depressed part 73 of the spring assembly 3 is adjusted to coincide with that of the protruding part 86 of the roll pipe assembly 80. Then, the spring assembly 3 is pushed into the tunnel 82 of the roll pipe assembly 80, and the cover assembly 5 is coupled to both end parts of the roll pipe 81 and the pulling bar assembly 40.

That is, the cover assemblies 5 at both sides are pushed toward each other so that the fixing shaft 90 can be inserted into the hexagonal hole 13a of the cover assembly 5, the depressed part 21 of the roll socket 20 is inserted into the protruding part 86 of the roll pipe assembly 80, and the pulling shaft 15 of the cover assembly 5 is inserted into the tunnel 46 of the pulling bar assembly 40.

Then, the fixing shaft 90 and the pulling bar assembly 40 are fixed by inserting and fixing the screws 17a, 16a into the mounting holes 92, 42 through the through holes 17, 16 of the roll cover 10.

The rolling device 100 assembled as described above has the roll cover 10 at each cover assembly 5, the fixing shaft 90 and the pulling bar 41 to be firmly fixed by the screws 17a, 16a. The fixing element 60 is also fixed because the fixing shaft 90 is inserted into the fixing element 60.

On the other hand, the roll pipe 81, the roll socket 20 which is inserted at each end part of the roll pipe 81 and the roll driving element 70 are fixed together. Also, the pulling bar 41 is always put at the upper side of the curtain sheet 120 and the pulling chain 300. Therefore, if the roll pipe 81 is rotated in one direction, both roll sockets 20 and the roll driving element 70 are rotated at the same time, so that an elastical restoring energy is saved in the driving spring 50.

Hereinafter is described the roman shade curtain which has the rolling device 100 according to the exemplary embodiment of the present invention as described above.

Referring to FIG. 1 to FIG. 3, the magic tapes 130 and 130a which are provided at the upper and the lower end parts of the curtain sheet 120 is attached to the magic tapes 132 and 133 which are formed at the adjusting device 2 and the rolling device 100 respectively.

Then, the adjuster 170 is driven by using the driving chain 180 so that the pulling chain 300 is drawn downward. the curtain sheet 120a which has been rolled around the roll pipe 81 due to the weight of the rolling device 100 is unrolled to rotate the roll driving element 70 (refer to FIG. 4).

While the driving spring 50 is rotated, the elastic energy is saved. Due to the elastic restoring force of the driving spring 50, the pulling bar 41 strongly pushes the curtain sheet 120 in a direction where the pulling bar 41 receives an elastic restoring force.

Also, the roll pipe 81 always tries to roll the curtain sheet 120 and move up due to the elastic restoring energy which has been saved during the rotation of the driving spring 50. However, the weight of the rolling device 100 is set such that the roll pipe 81 can not move up by the energy generated by the driving spring 50 alone.

Therefore, if the rolling device 100 suspended by the pulling chain 300 is moved upward by the rotation of the driving chain 180, the curtain sheet 120 is rolled around the roll pipe 81 as the elastic restoring energy that has been saved in the driving spring 50 is lost as much as the distance where the rolling device 100 is moved upward.

To be more specific about the operation of the adjusting device 2 and the rolling device 100, the gravitational force acting on the rolling device 100 is set to be bigger than the elastic restoring force which is saved in the driving spring 50 while the roll pipe 81 is rotated.

In this case, if the pulling chain 300 is drawn downward by using the upper roman shade adjusting device 2, the rolling device 100 moves downward while it unrolls the curtain sheet 120a that has been rolled around the roll pipe 81 due to the gravitational force acting thereon.

Also, the driving spring 50 saves the elastic restoring energy while it is rotated.

On the contrary, if the rolling device 100 is moved upward by using the adjusting device 2 to roll and move upward the curtain sheet 120, the roll pipe 81 is driven by the elastic restoring energy saved in the driving spring 50 thus rolling the curtain sheet 120 around the roll pipe 81.

In this case, the pulling chain 300 of the adjusting device 2 performs pulling function by which the rolling device 100 is moved vertically, leveling function where the rolling device 100 is maintained to be horizontally extended, and positioning function where the pulling bar 41 is always located at the upper side of the rolling device 100.

Hereinafter is described a method for attaching the curtain sheet 120 to the adjusting device 2 and the rolling device 100.

First, the adjusting device 2 is mounted on a ceiling and the rolling device 100 is taken down to a ground in a state that it is coupled to the pulling chain 300. Then, the roll pipe 81 is rotated to predetermined times and the braking hole 18 of the roll cover 10 is inserted by a gimlet or other, so that the braking hole 23 of the roll socket 20 is inserted by the gimlet thus stopping the rotation of the roll pipe 81.

Then, as shown in FIG. 3, the magic tapes 130 and 130a which are provided at the upper and lower end parts of the curtain sheet 120 are attached to the magic tapes 132 and 133 which are formed at the adjusting device 2 and the rolling device 100 respectively. Then, the gimlet that has been inserted into the braking holes 18 and 23 is removed.

Accordingly, the rolling device 100 tries to rotate the roll pipe 81 and roll the lower part of the curtain sheet 120 to be moved upward by using the energy saved in the spring assembly 3. However, the rolling device 100 can not roll up the curtain sheet 120 due to its weight.

If the adjuster 170 is rotated by using the driving chain 180 mounted to the adjuster 170 thus moving the rolling device 100 up till the rolling device 100 contacts the adjusting device 2, the roll pipe 81 is rotated as much as the the rolling device 100 is moved up thus rolling the curtain sheet 120 around the roll pipe 81, and the energy saved in the spring assembly 3 is almost exhausted.

On the contrary, the method for detaching the curtain sheet 120 from the adjusting device 2 and the rolling device 100 is the opposite to that for attaching the curtain sheet 120.

According to the methods for attaching and detaching the curtain sheet 120 as described above, a user can easily attach or detach the curtain sheet 120 after or before washing the curtain 120.

1. A rolling device for roll blind comprising:
a roll pipe assembly having a tunner therein in an extending direction;
a pair of cover assemblies inserted into and coupled to both end parts of the roll pipe assembly;
a fixing shaft accommodated in the tunnel of the roll pipe assembly and having both end parts prevented from being rotated by each cover assembly; and
a spring assembly being an elastic rotating element which is accommodated in the roll pipe assembly and accommodates the fixing shaft therein, and having one end part which is integrally rotated with the roll pipe assembly and the other end part whose rotation is prevented by the fixing shaft.

2. The rolling device for roll blind according to claim 1 further comprising a pulling bar assembly which is disposed in parallel with the roll pipe assembly and has both end parts coupled to each cover assembly, and which is coupled to a pulling chain at the opposite side from the roll pipe assembly.

3. The rolling device for roll blind according to claim 1, wherein the roll pipe assembly has a cylindrical roll pipe which accommodates the fixing shaft,
the spring assembly has a roll driving element which is integrally rotated with the roll pipe, a fixing element whose rotation is prevented by the fixing shaft, and a driving spring which has an end part that is integrally rotated with the roll driving element and the other end part that is fixed by the fixing element.

4. The rolling device for roll blind according to claim 1, wherein the roll pipe assembly has a cylindrical roll pipe which accommodates the fixing shaft,
the cover assembly has a roll socket which is inserted into an end part of the roll pipe and to be integrally rotated with the roll pipe and a roll cover which rotatably supports the roll socket,
the roll socket and the roll cover have a braking hole respectively to correspond to each other in a radial direction.
